(19) United States
(12) Patent Application Publication
(10) Pub. No.: US 2017/0109411 A1
(43) Pub. Date: Apr. 20, 2017

(54) ASSISTED CREATION OF A SEARCH QUERY

(71) Applicant: Linkedln Corporation, Mountain View, CA (US)

(72) Inventors: Rahim Daya, San Francisco, CA (US); Abhishek Gupta, San Francisco, CA (US); Shakti Dhirendraji Sinha, Sunnyvale, CA (US); Satya Pradeep Kanduri, Mountain View, CA (US); Xianren Wu, Santa Clara, CA (US); Gayathiri Ramadevi Lakshmanan, Santa Clara, CA (US); Bo Xiang Wu, Sunnyvale, CA (US); Vasili Onjea, San Jose, CA (US); Jordan Anthony Saints, Sunnyvale, CA (US); Timothy Patrick Jordt, San Francisco, CA (US); Gregory Alan Walloch, Santa Cruz, CA (US); Zachary Tyler Piepmeyer, San Francisco, CA (US)

(21) Appl. No.: 15/253,381

(22) Filed: Aug. 31, 2016

Related U.S. Application Data
(60) Provisional application No. 62/241,375, filed on Oct. 14, 2015.

(51) Int. Cl. G06F 17/30; G06F 3/0482

(52) U.S. Cl. CPC G06F 17/30554; G06F 17/3053; G06F 3/0482; G06Q 10/1053

(57) ABSTRACT

System and techniques for autonomously adaptive performance monitoring are described herein. A text input field may be presented on a graphical user interface. A flow-selector may be presented in contact with the text input field in response to receiving user input at the text input field. Here, the flow-selector includes a set of flow choices selected based on the user input. A user selection of a flow choice may be received. Next-steps flow elements may be presented in response to the user selection. User query choices may be collected from the next-steps flow elements to populate a query template corresponding to the flow choice. The query template is executed to produce search results.

### CLAIM OF PRIORITY

This patent application claims the benefit of priority, under 35 U.S.C. §119, to U.S. Provisional Application Ser. No. 62/241,375, titled “SEARCH STARTERS” and filed on Oct. 14, 2015, the entirety of which is hereby incorporated by reference herein.

### TECHNICAL FIELD

Embodiments described herein generally relate to search engines and more specifically to assisted creation of a search query.

### BACKGROUND

Search engines generally provide a structured mechanism to enter a request for data and match that request to items in a data store. These data store items generally include multiple fields that include data or references to other data. The data request is often structured with respect to a known field configuration of the data in the data store. Thus, queries are formulated that, for example, request title fields that include all or part of an article title.

After receiving a query, the search engine generally parses the query to determine when and where to search the data store, creating a query plan. The search engine then executes the query plan collecting results. These results, once located, may be further manipulated according to other parameters of the query. These manipulations may include sorting the results, aggregating results to produce a number, etc. The final result, following manipulations, is then returned to an agent to, for example, display the search results to a user. In some examples, the user may subsequent requests of the search engine for an already completed search to manipulate the search results further.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of a system for assisted creation of a search query, according to an embodiment.

FIG. 2 illustrates the functional components of a social networking service, according to an embodiment.

FIGS. 3-6 illustrate examples of user interface elements for assisted creation of a search query, according to an embodiment.

FIG. 7 illustrates an example of a method for assisted creation of a search query, according to an embodiment.

FIG. 8 is a block diagram illustrating an example of a machine upon which one or more embodiments may be implemented.

### DETAILED DESCRIPTION

A common problem arises for users using sophisticated search tools for complex data: the user must invest significant time in learning the search tools (query language, tuning parameters, etc) and possibly collect and organize previous successful queries to use again in the future. These problems may be exacerbated in search tasks that occur often but with different goals, such as the work of an employment recruiter search an applicant database. In tasks such as these, the user may be spending time learning how to search rather than performing their primary function, such as recruiting people for open positions.

Query building tools may alleviate some problems noted above. Rather than providing a bare interface to enter the fields and values to be searched, these tools may accept an initial entered value and suggest subsequent values to select. In some examples, a workflow may be used to guide a user through query generation. In an example, the workflow is selected by the user and then the user commences to follow prompts to complete the workflow. A problem with many workflow implementations may include the rigid nature of the resultant workflow. For example, after a user has become more accustomed to a particular query exercise, the workflow prompts may be a slow or otherwise cumbersome interface for that user.

To address the issues noted above, techniques and systems for assisted creation of a search query are disclosed herein. A text entry user interface is presented to the user. As the user begins to type the query, the input is used to provide suggested query completion options (e.g., a type-ahead). Rather than a traditional type-ahead, however, the completion options are those of several possible workflows. Thus, when the user selects a particular option, a workflow is also selected. The workflow elements, as completed, may be put into the text entry as pills, graphical elements representing a previous selection. A background text prompt on the text entry element may then instruct the user as to a next workflow prompt. At any time, the user may invoke the search to exit the workflow and begin a search with the entered parameters. In this manner, the user interacts with a familiar search box while gaining the benefit of guided search creation without the rigid workflow interfaces of the past. Additional examples and details are discussed below.

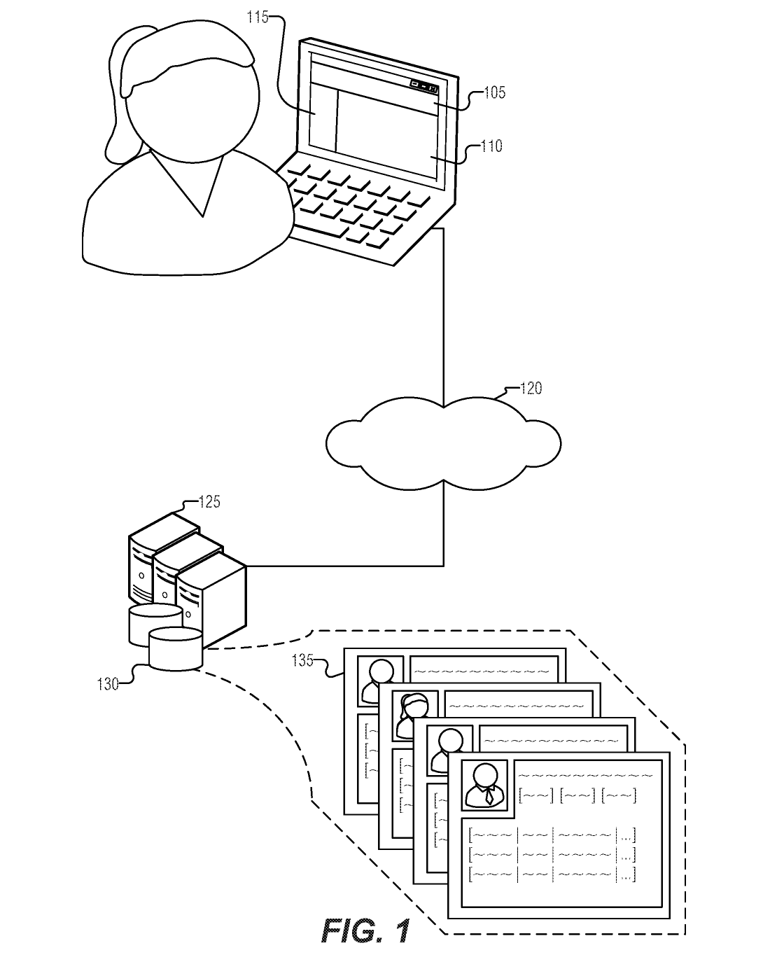

FIG. 1 illustrates an example of a system 125 for assisted creation of a search query, according to an embodiment. The system 125, when in operation, is communicatively coupled to a network 120 and a data store 130. The network 120 permits the system 125 to communicate a user interface and receive user input from a user device, such as a laptop, tablet, smart phone, etc. As illustrated, the user interface is a search interface that includes a top rail 105, a side rail 115, and a results area 110. The data store 130 contains records 135, here illustrated as candidate records for possible employees. While the example of a recruiter searching for candidates is used throughout this document, other types of records and searches similar benefit from the systems and techniques discussed herein.

The components of the system 125 are implemented in computer hardware, such as with memory, storage (e.g., tape, platter-based hard drives, etc.), transceivers, search engines, query interfaces, multiplexers, circuits, etc., that may be configured by software for a particular operation. As a convenience, the operations of the system 125 will be described with three components, a query interface, a multiplexer, and a search engine.

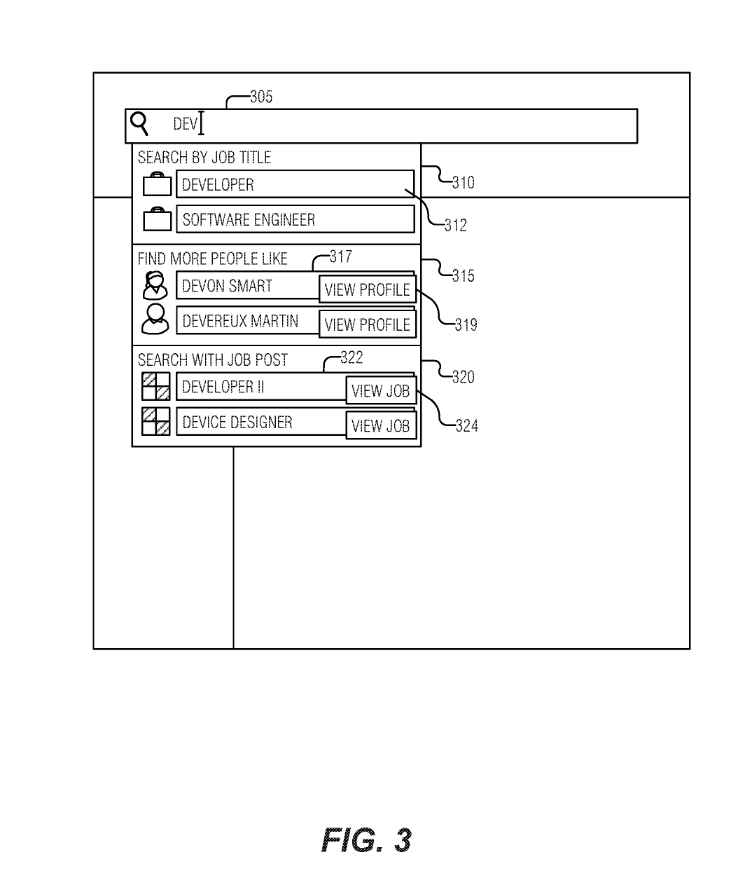

The query interface is arranged to present a text input field on a graphical user interface (GUI) and receive user input at the text field. The query interface may be coupled to the multiplexer, the multiplexer accepting several inputs and producing a single output. In response to receiving the user input, the query interface, perhaps as fed by the multiplexer, is arranged to present a flow-selector in proximity to (e.g., touching, in contact with, within a predetermined distance, etc.) the text input field. This example illustrates the use of a standard search interface, the text field, that users are familiar with and overloading it to allow selection of a work flow without interrupting the user. Thus, the flow-selector includes a set of flow choices selected based on the user input. In an example, the flow choices include identification of a flow and identification of an example result. An illustration of this scenario is given with respect to FIG. 3. Essentially, the type-ahead is extended to not only include likely text completion suggestions, but to group these with the flow selection. In an example, the flows presented in the flow-selector are based on the type-ahead suggestion found. These suggestions may be implemented in any one of a number of ways, such as using query expansion, running a query, and ranking results. In an example, the flows are selected based on flow use by other searchers. In these examples, the type-ahead suggestions incorporate both the flow and the currently entered data in the input text field.

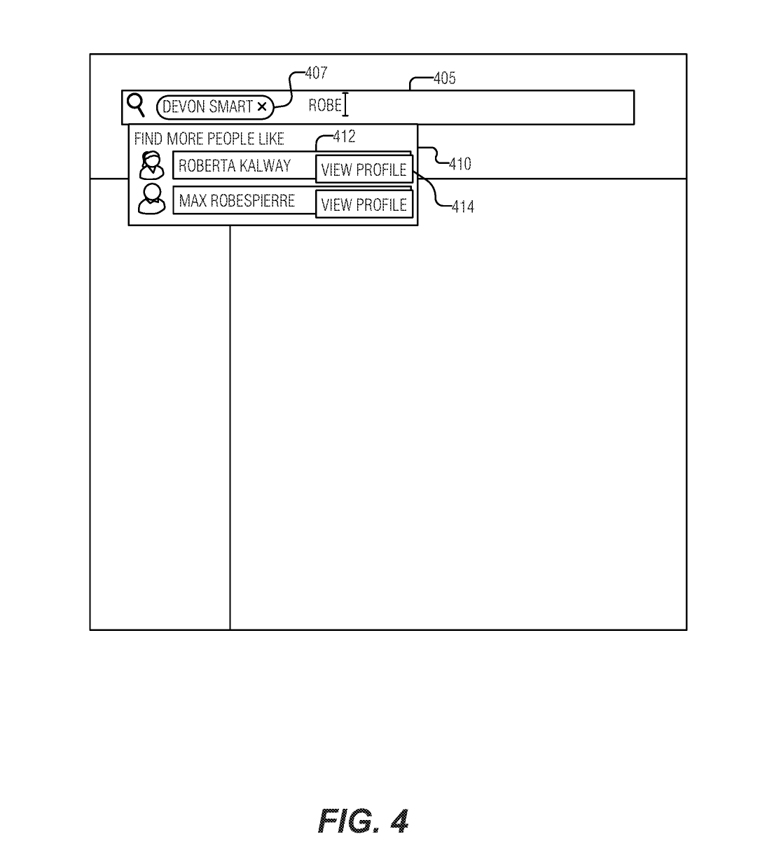

The query interface is arranged to receive user selection of a flow choice. In an example, the flow is selected by user selection of a type-ahead option. In this example, the user need no separately identify the flow being selected, but rather selects an option from the flow. This streamlines the user interface and increases overall user satisfaction. In an example, the user selection includes a selection of a second result presented in the flow choice. In this example, the flow may include no additional questions, but may, for example, accept additional input of the original data point. For example, if one wanted to search for job candidates using an example candidate, the initial type-ahead may be that example candidate. However, in such an example based search, the peculiarities of the first example candidate may limit the results to those candidates with those peculiarities. For example, if the example candidate is a software developer that likes kayaking, the machine intelligence that accepts that candidate's data may skew towards including kayaking aficionados. To address this issue, additional candidates may be identified and used for the sample set. To facilitate this exercise, the workflow proceeds to prompt the user to search for additional ideal candidates. Now, with a more robust sample set, the similarities between the example candidates may be gleaned by the searching intelligence and used for a more productive search. An example of this interface is given with respect to FIG. 4.

In response to user selection of the flow choice, the query interface is arranged to present next-steps flow elements. Here, the work flow is engaged and additional questions may be posed to facilitate building the query. As noted above, these elements prompt or guide the user through query building based on a selected work flow. These next steps may be presented as background text on the text input field. In so doing, the user need not use the mouse or otherwise leave the comfortable text input field to add data to the work flow.

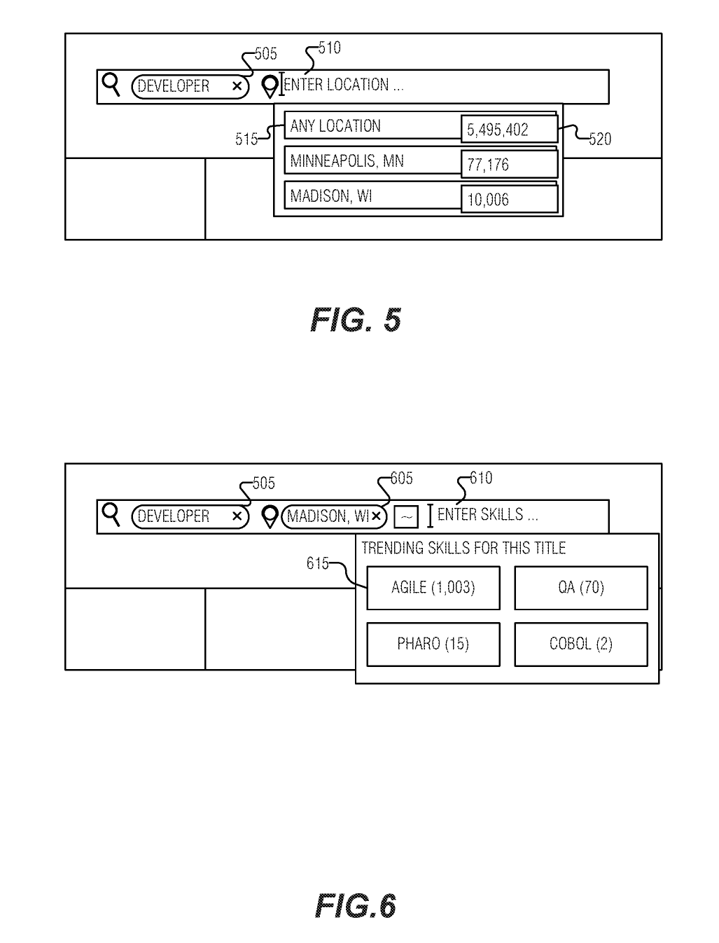

The query interface then collects user query choices from the next-steps flow elements to populate a query template corresponding to the flow choice of the user. The user query choice collection may be facilitated by the multiplexer, accepting the various input choices from the user and prompting the user interface to pose additional data requests of the user. In an example, the flow choice is at least one of a position, a person, or a posting. These example flow choices are pertinent to, for example, recruitment searches by the user. Here, the flow choices correspond to searching by example using a person as the example or a job posting as an example. Both of these workflows accept data to identify record 135 in the data store 130. Once these records are identified, attributes of the records are extracted and used as parameters to the search engine. The position workflow is a more traditional search in which the user will be prompted to enter specific details about a position, such as location, skills required for the positions, etc. Examples of these user interface elements are illustrated with respect to FIGS. 5 and 6.

In an example, to collect the user query choices from the next-steps flow elements, the query interface is arranged to replace the user input at the text field with a graphical element in the text field and to move a cursor after the graphical element in the text field. This graphical technique of marking previously made choices in the text field permits the user to be notified of which choices have already been made. In an example, the graphical element takes the form of a pill including at least one of an edit or delete control. Thus, the user may easily remove previous choices or edit them without, for example, having to restart the work flow or otherwise interrupt her general search interaction.

The search engine is arranged to execute the query template to produce search results. Executing the query template involves extracting the key value pairs from the query and formatting those to interact with the search engine. Thus, if a position (key) and software manager (value) is extracted, the search may be formulated such as SELECT * FROM RECORDS WHERE position EQUALS “software manager” or the like. This simple example may be modified based on the application programming interface (API) for the search engine. Additional formats to facilitate machine intelligence based search mechanisms may also be employed, such as selecting a particular input neuron, or set of input neurons, based on the key and providing the corresponding value as inputs to these neurons.

To execute the query template, the search engine is also arranged to extract an entity from a result in the intermediate results that is not found in the query template. Here, an entity is a type of attribute in a record. For example, location, experience level, hobby, etc. are entities while a person's name is an attribute. An entity may include additional attributes. For example, the job title entity may include a regional variation and relation to another entity. For example, the title “software engineer” may be a local title to New York that is related to (e.g., the same as) the title “software developer” in California.

In an example, to extract the entity, the search engine is arranged to rank entities by a closeness metric from an entity in the query template. Here, the entities in, for example, a search-by-example search are used to rank entities in other records. The closer a set of entities are to those already in the query template, the more relevant the corresponding record may be considered. In an example, the closeness metric is based on a statistical position of the entity in a population. The statistical position may be one of a mean, median, standard deviation, etc. Here, the closeness is the relation between the query template entity and the found entity. For example, if they are both near the median (e.g., within a threshold distance of the median adjusted for the sample size), then they are considered close. In an example, the closeness is the raw value of the difference, such that the distance from the median of the query template entity is subtracted from that of the candidate entity, the result being the closeness metric.

In an example, the closeness metric used is dependent on an entity type of the entity. For example, the closeness metric and calculation is different than that of position. This permits a flexible approach to a wide variety of data that may be compared. In an example, the entity type is company. Here, the closeness metric is based on frequencies with which searchers visit company objects. That is, the more interested the candidate is in the company, as evidenced by the number of company searches the candidate has made, the number of company profiles or websites visited, etc., the greater the closeness of that candidate to a company entity in the query template. In another example where the entity type is a company, the closeness metric is based on competition between organizations represented by the entities. This competition may be a score gathered from an external source, such as market research, litigation records, or past cross hiring activity (e.g., company A hires talent from company B and vice versa).

In an example, the entity type is title. Here the closeness metric is based on searcher session occurrence of titles. The use of titles during the same session notes that the searcher may have been looking for something previously but had not yet hit on the right combination of query elements. Thus, including previously searched titles permits an expansion into titles that the user in which the user was already interested. Similarly, in an example, these titles may be given a poor closeness score because the user had already searched them and found them lacking. In an example, the entity type is description. Here the closeness metric is a distance derived from semantic analysis. The particular semantic analysis may be inverse document frequency, word vector approximations, or the like. These techniques produce a numeric value that may be used to calculate a distance. Often, a space with a number of dimensions equal to the sample documents is created. Words, phrases, or other parts of speech are plotted along each dimension based on their occurrence or importance in a given sample. These coordinates, much like those on a map, may then be compared to arrive at a distance. This distance is an example closeness metric for description entities.

An example of using the above given a set of ideal candidates may proceed as follows. The multiplexer will accept the set of ideal candidates and generate a search query including skills, titles, companies etc. Then, the query will be submitted to the search engine to get top results. The results of the query generation will be evaluated to suggest different strategies or parameter settings for offline indexing, de-normalization, or other enhancements to the search engine. Techniques of query generation which indicate good performance will be selected and deployed in the search engine for subsequent queries. Because search engine performance is often dependent on how the ranking function uses information in search queries, the evaluation method is informed by the ranking function.

An example of training data for the evaluation may include, within a same search session, whether a searcher sends inmail (e.g., a message within a social media service) to a number of results. Here, the results are likely to be good fits for the position the searcher has in mind. Thus, the results are similar to each other and if the searcher uses some of them as a query starter (e.g., ideal candidates search-by-example) for the position, the others are also likely to be relevant results.

Thus, given a search session, some results are randomly picked that the searcher sends inmail to as ideal candidates. The rest of the results with inmail are considered to be relevant to the ideal candidates. The results without inmail are considered to be non-relevant. Given the data, different parts in the generated queries, such as skills, titles and companies, are evaluated separately. For example, given a set of ideal candidates as above, a set of skills s={s1, s2 . . . sk} are extracted. This set is evaluated by computing a reputation score of a relevant result (on average) on these skills: Reputation(R+, S) and reputation score of a non-relevant result on these skills: Reputation(R−, S). In an example, this is the same manner in which the ranking function uses skills in the query to rank results (e.g., using sum of reputation scores of a result on the skills in query as a feature). Thus, if Reputation(R±, S)>Reputation(R−, S), the relevant results will be likely to be ranked higher than non-relevant results. So, this way of evaluation will be in-line with performance of the query on the current search system.

Similarly, for a set of titles T, the titles may be evaluated by comparing how well they match with current titles in relevant results vs. how they match with current titles in non-relevant results. When a current search ranking function gives a high weight to current title matches, if T matches better with the titles of relevant results than the titles of non-relevant results, query T will perform well.

To execute the query template, the search engine is also arranged to select the entity based on the closeness metric. As noted above, the closeness metrics provide a measure as to how close candidate entities are to those already included in the query template (for example, already selected by the user). In an example, selecting the entity based on the closeness metric includes the search engine selecting the entity when the closeness metric is beyond a threshold. In this example, entities that are too close to those already part of the query template are avoided. This permits the query template to expand the search to include related, but different, entities. In an example, to select the entity based on the closeness metric, the search engine is arranged to rank entities using respective closeness metrics to create an ordered set and to select entities in order from the ordered set until a predetermined number of entities are selected. Thus, if there are too many candidate records, the entities are sorted and a preset number of slots are filled based on the sorting.

To execute the query template, the search engine is also arranged to add the entity to the query template. As noted above, adding an entity to the query template changes the systems behavior with respect to additional entities being added, the types of type-ahead values being presented, etc. In this way, the user's previous choices further narrow and enhance the given search.

In an example, executing the query template happens on a continuous basis. That is, as each new piece of information is gleaned from the user, the search engine produces results that will be displayed in the results area 110. In this manner, the user is treated to an interactive guided search and may stop whenever the results meet her expectations. In an example, to execute the query template, the search engine is to perform a preliminary search based on an element of the query template to produce intermediate results.

Implementing the system 125 described above solves a number of technical problems related to complex search tools. First, the user is not burdened to memorize or train at length to make use of sophisticated searching. Second, the traditional user interface is not given up for a complex interface involving work flow selections and questionnaires. Rather, an elegant search box is used, its type-ahead overloaded to permit workflow selection, and its already entered content transformed, in place, to represent previous choices. Thus, the user gains the benefit of a sophisticated workflow engine without having to leave the familiar search interface.

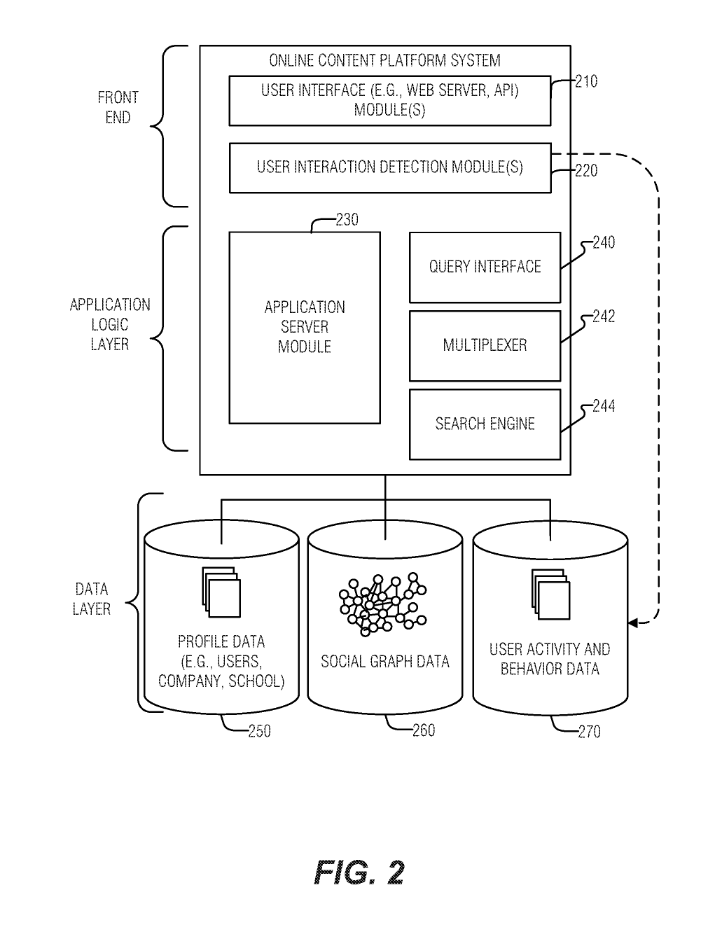

FIG. 2 illustrates the functional components of a social networking service 200, according to an embodiment. The social networking service may be used to host, or implement, the system described above in FIG. 1. A front end module may comprise a user interface module (e.g., a web server) 220, which receives requests from various client-computing devices, and communicates appropriate responses to the requesting client devices. For example, the user interface module(s) 210 may receive requests in the form of Hypertext Transport Protocol (HTTP) requests, or other network-based, application programming interface (API) requests (e.g., from a dedicated social networking service application running on a client device). In addition, a user interaction and detection module 220 may be provided to detect various interactions that users (e.g., members) have with different applications, services and content presented. Upon detecting a particular interaction, the user interaction and detection module 220 logs the interaction, including the type of interaction and any meta-data relating to the interaction, in the member activity and behavior database 270.

An application logic layer may include one or more various application server modules 230, which, in conjunction with the user interface module(s) 210, generate various graphical user interfaces (e.g., web pages) with data retrieved from various data sources in the data layer. With some embodiments, application server module 230 is used to implement the functionality associated with various applications and/or services provided by the social networking service as discussed above.

Application logic layer may also include the query interface 240, multiplexer 242, and search engine 244. As discussed in FIG. 1, these components facilitate assisted creation of a search query.

A data layer may include several databases, such as a database 250 for storing profile data, including both member profile data as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 250. Similarly, when a representative of an organization initially registers the organization with the social networking service, the representative may be prompted to provide certain information about the organization. This information may be stored, for example, in the database 250, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that the members establish with other members, or with other entities and objects, is stored and maintained within a social graph in the social graph database 260. Also, as members interact with the various applications, services, and content made available via the social networking service, the members' interactions and behavior (e.g., content viewed, links or buttons selected, messages responded to, etc.) may be tracked and information concerning the member's activities and behavior may be logged or stored, for example by the member activity and behavior database 270.

With some embodiments, the social networking service 200 provides an application programming interface (API) module with the user interface module 210 via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

FIGS. 3-6 illustrate examples of user interface elements for assisted creation of a search query, according to an embodiment. FIG. 3 illustrates a search text field 305 in the top rail illustrated in FIG. 1. Here, the user has entered a partial search in the form of “DEV.” The type-ahead element is currently displaying candidate results for “DEV” along with flow choices. For example, the flow choice “SEARCH BY JOB TITLE” 310 is displayed first along with candidate results “DEVELOPER” 312 and “SOFTWARE ENGINEER.” The “SOFTWARE ENGINEER” choice represents an entity closeness based on entity attributes, such as a geographical affinity of terms that stand for the same job.

The flow choice 315 is a search-by-example flow where a person's profile (e.g., previous candidate) is used to provide query parameters. In the illustrated example, the candidate result 317 for “DEVON SMART” may also include an investigation element 319, such as a link, button, or other control such that the user may review the result to ascertain its pertinence to the search.

The flow choice 320 is another search-by-example flow where a previous job posting is used to provide query parameters. Again, the candidate result 324 includes an investigation element 324 so that the user may review the suggested example.

As noted above, it is clear from the interface which flow the user is selecting when the user selects a candidate result. Thus, when the user selects “DEVON SMART,” for example, the user is also aware that he is selecting the “FIND MORE PEOPLE LIKE” flow 315. FIG. 2 illustrates the result of such a selection. Note that the choice “DEVON SMART” is transformed in the text field 405 into a pill 407 including a delete (“X”) element. As the “FIND MORE PEOPLE LIKE” flow 410 was selected, the type-ahead now only displays candidate results for that flow. The user has entered in additional text, “ROBE,” prompting flow specific type-ahead suggestions, such as suggestion 412, again with investigation element 414. This workflow allows the entry or several example records to be used as raw material for search parameters.

FIG. 5 illustrates a user selection of a position flow. Here, the previous selection of a “DEVELOPER” position is represented as pill 505 in the text field. This flow includes a secondary inquiry as to a location for the position. The prompt in the text field changes and a prompt 510 is written on the text field after the cursor. Typically the prompt 510 is in a muted color, such as grey on white instead of text's normal black on white to further distinguish the nature of the prompt 510 to the user. Candidate location results 515 are displayed in a type-ahead based on the query template to-date (e.g., “DEVELOPER” being selected). These results may include a count 520, giving the user an idea of how adding a location will affect the search results.

FIG. 6 illustrates the position flow after the location is selected. Again, the previous selections are represented as pills 505 and 605. The user is then prompted 610 to add skills. Now, the type-ahead includes skill results 615.

At any time during the entry of the flow choices and user selections, the user may invoke the search, for example, using the magnification icon. Thus, the intuitive nature with which the user is guided also allows the experience searcher to immediately exit the flow when the search results appear to meet the searcher's goals.

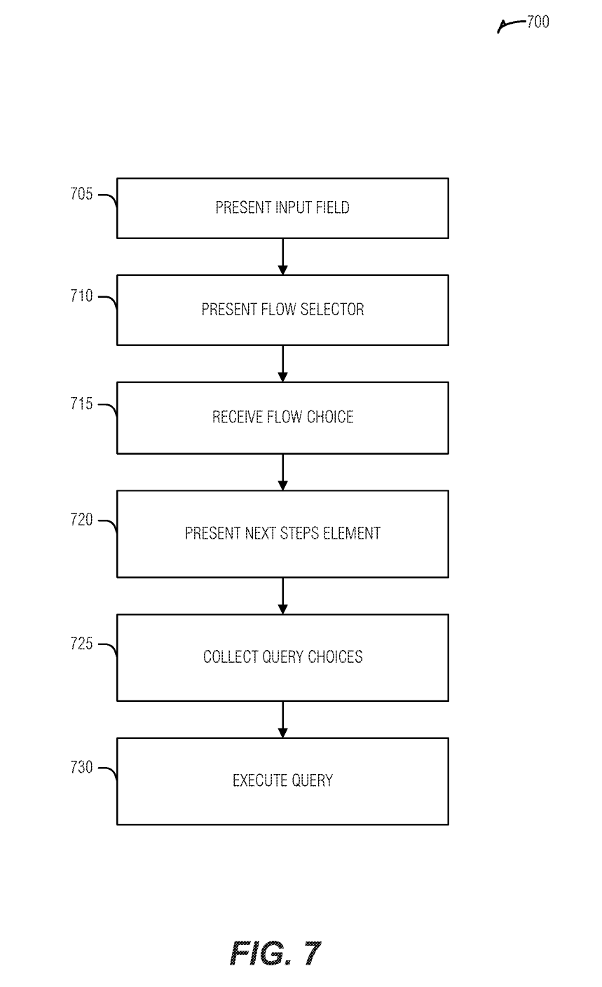

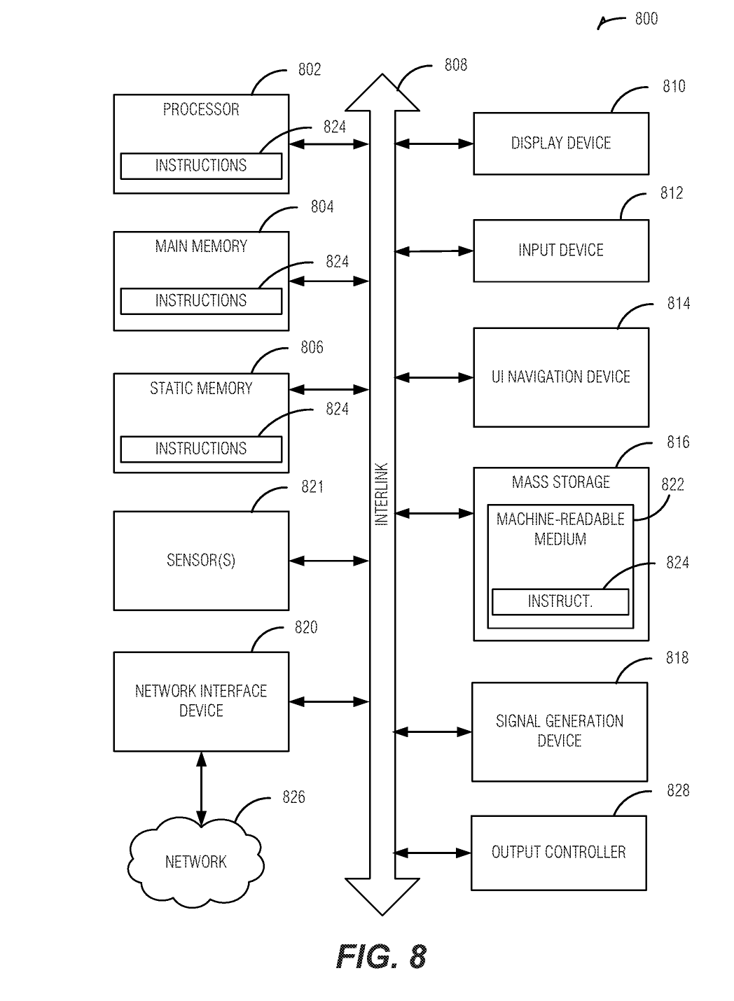

FIG. 7 illustrates an example of a method 700 for assisted creation of a search query, according to an embodiment. The operations of the method 700 are carried out by hardware, such as that described above and below.

At operation 705, a text input field is presented on a graphical user interface (GUI).

At operation 710, a flow-selector is presented in proximity to the text input field in response to receiving user input at the text input field. In an example, the flow-selector includes a set of flow choices selected based on the user input. In an example, the flow choices include identification of a flow and identification of an example result.

At operation 715, user selection of a flow choice is received. In an example, the user selection includes a selection of a second result presented in the flow choice.

At operation 720, next-steps flow elements are presented in response to the user selection.

At operation 725, user query choices are collected from the next-steps flow elements to populate a query template corresponding to the flow choice In an example, the flow choice is at least one of a position, a person, or a posting. In an example, collecting user query choices from the next-steps flow elements includes replacing the user input at the text field with a graphical element in the text field and moving a cursor after the graphical element in the text field.

At operation 730, the query template is executed to produce search results. In an example, executing the query template includes performing a preliminary search based on an element of the query template to produce intermediate results.

Executing the query template also includes extracting an entity from a result in the intermediate results that is not found in the query template. In an example, extracting the entity includes ranking entities by a closeness metric from an entity in the query template. In an example, the closeness metric is based on a statistical position of the entity in a population. In an example, the closeness metric used is dependent on an entity type of the entity. In an example, the entity type is company and the closeness metric is based on frequencies with which searchers visit company objects. In an example, the entity type is company and the closeness metric is based competition between organizations represented by the entities. In an example, the entity type is title and the closeness metric is based on searcher session occurrence of titles. In an example, the entity type is description and the closeness metric is a distance derived from semantic analysis.

Executing the query template also includes selecting the entity based on the closeness metric. In an example, selecting the entity based on the closeness metric includes selecting the entity when the closeness metric is beyond a threshold.

In an example, selecting the entity based on the closeness metric includes ranking entities using respective closeness metrics to create an ordered set and selecting entities in order from the ordered set until a predetermined number of entities are selected.

Executing the query template also includes adding the entity to the query template.

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, or a number of components, or mechanisms. Circuitry is a collection of circuits implemented in tangible entities that include hardware e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMAX®, IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### ADDITIONAL NOTES & EXAMPLES

Example 1 is a system for assisted creation of a searching query, the system comprising: a processor; and a memory including instructions that, when executed by the processor, cause the processor to: present a text input field on a graphical user interface (GUI); present a flow-selector in proximity to the text input field in response to receiving user input at the text input field, the flow-selector including a set of flow choices selected based on the user input; receive user selection of a flow choice; present next-steps flow elements in response to the user selection; collect user query choices from the next-steps flow elements to populate a query template corresponding to the flow choice; and execute the query template to produce search results.

In Example 2, the subject matter of Example 1 optionally includes wherein the flow choices include identification of a flow and identification of an example result.

In Example 3, the subject matter of any one or more of Examples 1-2 optionally include wherein executing the query template includes: performing a preliminary search based on an element of the query template to produce intermediate results; extracting an entity from a result in the intermediate results that is not found in the query template; and adding the entity to the query template.

In Example 4, the subject matter of Example 3 optionally includes wherein extracting the entity includes: ranking entities by a closeness metric from an entity in the query template; and selecting the entity based on the closeness metric.

In Example 5, the subject matter of Example 4 optionally includes wherein selecting the entity based on the closeness metric includes selecting the entity when the closeness metric is beyond a threshold.

In Example 6, the subject matter of any one or more of Examples 4-5 optionally include wherein selecting the entity based on the closeness metric includes: ranking entities using respective closeness metrics to create an ordered set; and selecting entities in order from the ordered set until a predetermined number of entities are selected.

In Example 7, the subject matter of any one or more of Examples 4-6 optionally include wherein the closeness metric used is dependent on an entity type of the entity.

In Example 8, the subject matter of Example 7 optionally includes wherein the entity type is company, and wherein the closeness metric is based on frequencies with which searchers visit company objects.

In Example 9, the subject matter of any one or more of Examples 7-8 optionally include wherein the entity type is company, and wherein the closeness metric is based competition between organizations represented by the entities.

In Example 10, the subject matter of any one or more of Examples 7-9 optionally include wherein the entity type is title, and wherein the closeness metric is based on searcher session occurrence of titles.

In Example 11, the subject matter of any one or more of Examples 7-10 optionally include wherein the entity type is description, and wherein the closeness metric is a distance derived from semantic analysis.

In Example 12, the subject matter of any one or more of Examples 4-11 optionally include wherein the closeness metric is based on a statistical position of the entity in a population.

In Example 13, the subject matter of any one or more of Examples 1-12 optionally include wherein collecting user query choices from the next-steps flow elements includes: replacing the user input at the text field with a graphical element in the text field; and moving a cursor after the graphical element in the text field.

In Example 14, the subject matter of any one or more of Examples 1-13 optionally include wherein the flow choice is at least one of a position, a person, or a posting.

In Example 15, the subject matter of any one or more of Examples 2-14 optionally include wherein the user selection includes a selection of a second result presented in the flow choice.

Example 16 is a method for assisted creation of a searching query, the method comprising: presenting a text input field on a graphical user interface (GUI); presenting a flow-selector in proximity to the text input field in response to receiving user input at the text input field, the flow-selector including a set of flow choices selected based on the user input; receiving user selection of a flow choice; presenting next-steps flow elements in response to the user selection; collecting user query choices from the next-steps flow elements to populate a query template corresponding to the flow choice; and executing the query template to produce search results.

in Example 17, the subject matter of Example 16 optionally includes wherein the flow choices include identification of a flow and identification of an example result.

In Example 18, the subject matter of any one or more of Examples 16-17 optionally include wherein executing the query template includes: performing a preliminary search based on an element of the query template to produce intermediate results; extracting an entity from a result in the intermediate results that is not found in the query template; and adding the entity to the query template.

in Example 19, the subject matter of Example 18 optionally includes wherein extracting the entity includes: ranking entities by a closeness metric from an entity in the query template; and selecting the entity based on the closeness metric.

In Example 20, the subject matter of Example 19 optionally includes wherein selecting the entity based on the closeness metric includes selecting the entity when the closeness metric is beyond a threshold.

In Example 21, the subject matter of any one or more of Examples 19-20 optionally include wherein selecting the entity based on the closeness metric includes: ranking entities using respective closeness metrics to create an ordered set; and selecting entities in order from the ordered set until a predetermined number of entities are selected.

In Example 22, the subject matter of any one or more of Examples 19-21 optionally include wherein the closeness metric used is dependent on an entity type of the entity.

In Example 23, the subject matter of Example 22 optionally includes wherein the entity type is company, and wherein the closeness metric is based on frequencies with which searchers visit company objects.

In Example 24, the subject matter of any one or more of Examples 22-23 optionally include wherein the entity type is company, and wherein the closeness metric is based competition between organizations represented by the entities.

In Example 25, the subject matter of any one or more of Examples 22-24 optionally include wherein the entity type is title, and wherein the closeness metric is based on searcher session occurrence of titles.

In Example 26, the subject matter of any one or more of Examples 22-25 optionally include wherein the entity type is description, and wherein the closeness metric is a distance derived from semantic analysis.

in Example 27, the subject matter of any one or more of Examples 19-26 optionally include wherein the closeness metric is based on a statistical position of the entity in a population.

In Example 28, the subject matter of any one or more of Examples 16-27 optionally include wherein collecting user query choices from the next-steps flow elements includes: replacing the user input at the text field with a graphical element in the text field; and moving a cursor after the graphical element in the text field.

In Example 29, the subject matter of any one or more of Examples 16-28 optionally include wherein the flow choice is at least one of a position, a person, or a posting.

In Example 30, the subject matter of any one or more of Examples 17-29 optionally include wherein the user selection includes a selection of a second result presented in the flow choice.

Example 31 is a machine readable medium including instructions that, when executed by a machine, cause the machine to perform operations comprising: presenting a text input field on a graphical user interface (GUI); presenting a flow-selector in proximity to the text input field in response to receiving user input at the text input field, the flow-selector including a set of flow choices selected based on the user input; receiving user selection of a flow choice; presenting next-steps flow elements in response to the user selection; collecting user query choices from the next-steps flow elements to populate a query template corresponding to the flow choice; and executing the query template to produce search results.

In Example 32, the subject matter of Example 31 optionally includes wherein the flow choices include identification of a flow and identification of an example result.

In Example 33, the subject matter of any one or more of Examples 31-32 optionally include wherein executing the query template includes: performing a preliminary search based on an element of the query template to produce intermediate results; extracting an entity from a result in the intermediate results that is not found in the query template; and adding the entity to the query template

In Example 34, the subject matter of Example 33 optionally includes wherein extracting the entity includes: ranking entities by a closeness metric from an entity in the query template; and selecting the entity based on the closeness metric.

In Example 35, the subject matter of Example 34 optionally includes wherein selecting the entity based on the closeness metric includes selecting the entity when the closeness metric is beyond a threshold.

In Example 36, the subject matter of any one or more of Examples 34-35 optionally include wherein selecting the entity based on the closeness metric includes: ranking entities using respective closeness metrics to create an ordered set; and selecting entities in order from the ordered set until a predetermined number of entities are selected.

in Example 37, the subject matter of any one or more of Examples 34-36 optionally include wherein the closeness metric used is dependent on an entity type of the entity.

In Example 38, the subject matter of Example 37 optionally includes wherein the entity type is company, and wherein the closeness metric is based on frequencies with which searchers visit company objects.

In Example 39, the subject matter of any one or more of Examples 37-38 optionally include wherein the entity type is company, and wherein the closeness metric is based competition between organizations represented by the entities.

In Example 40, the subject matter of any one or more of Examples 37-39 optionally include wherein the entity type is title, and wherein the closeness metric is based on searcher session occurrence of titles.

In Example 41, the subject matter of any one or more of Examples 37-40 optionally include wherein the entity type is description, and wherein the closeness metric is a distance derived from semantic analysis.

In Example 42, the subject matter of any one or more of Examples 34-41 optionally include wherein the closeness metric is based on a statistical position of the entity in a population.

In Example 43, the subject matter of any one or more of Examples 31-42 optionally include wherein collecting user query choices from the next-steps flow elements includes: replacing the user input at the text field with a graphical element in the text field; and moving a cursor after the graphical element in the text field.

In Example 44, the subject matter of any one or more of Examples 31-43 optionally include wherein the flow choice is at least one of a position, a person, or a posting.

In Example 45, the subject matter of any one or more of Examples 32-44 optionally include wherein the user selection includes a selection of a second result presented in the flow choice.

Example 46 is a method comprising: presenting a contextual menu as a user enters a search query, the contextual menu including search-flow options initialized to a portion of the query entered by the user; replacing the portion of the query with a graphical element in response to a user selection of a search-flow option, the graphical element summarizing the portion of the query entered; modifying an entry area for the search query with a prompt for additional query terms that are determined by the search-flow option selected; and executing a complete search query using the portion of the query and the additional query terms, the complete search query organization defined by the search-flow option selected by the user.

In Example 47, the subject matter of Example 46 optionally includes wherein the search-flow option is search by job title.

In Example 48, the subject matter of any one or more of Examples 46-47 optionally include wherein the search-flow option is search by candidate example.

In Example 49, the subject matter of any one or more of Examples 46-48 optionally include wherein the search-flow option is search by job post example.

In Example 50, the subject matter of any one or more of Examples 46-49 optionally include wherein the graphical element is a pill with text summarizing the potion of the query entered.

In Example 51, the subject matter of Example 50 optionally includes wherein a text entry area accepts the search query, and wherein the pill is placed in the text entry area.

Example 52 is a system comprising: a query interface to present a contextual menu as a user enters a search query, the contextual menu including search-flow options initialized to a portion of the query entered by the user; a multiplexer to replace the portion of the query with a graphical element in response to a user selection of a search-flow option, the graphical element summarizing the portion of the query entered; wherein the query interface is to modify an entry area for the search query with a prompt for additional query terms that are determined by the search-flow option selected; and a query engine to execute a complete search query using the portion of the query and the additional query terms, the complete search query organization defined by the search-flow option selected by the user.

In Example 53, the subject matter of Example 52 optionally includes wherein the search-flow option is search by job title.

In Example 54, the subject matter of any one or more of Examples 52-53 optionally include wherein the search-flow option is search by candidate example.

In Example 55, the subject matter of any one or more of Examples 52-54 optionally include wherein the search-flow option is search by job post example.

In Example 56, the subject matter of any one or more of Examples 52-55 optionally include wherein the graphical element is a pill with text summarizing the potion of the query entered.

In Example 57, the subject matter of Example 56 optionally includes wherein the pill is placed in the entry area.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples or one or more aspects thereof) may be used in combination with each other. Other embodiments may be used such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for assisted creation of a searching query, the system comprising:
a processor; and
a memory including instructions that, when executed by the processor, cause the processor to:
present a text input field on a graphical user interface (GUI);
present a flow-selector in proximity to the text input field in response to receiving user input at the text input field, the flow-selector including a set of flow choices selected based on the user input;
receive a user selection of a flow choice;
present next-steps flow elements in response to the user selection;
collect user query choices from the next-steps flow elements to populate a query template corresponding to the flow choice; and
execute the query template to produce search results.

2. The system of claim 1, wherein the flow choices include identification of a flow and identification of an example result.

3. The system of claim 1, wherein executing the query template includes:
performing a preliminary search based on an element of the query template to produce intermediate results;
extracting an entity from a result in the intermediate results that is not found in the query template; and
adding the entity to the query template.

4. The system of claim 3, wherein extracting entity includes:
ranking entities by a closeness metric from an entity in the query template; and
selecting the entity based on the closeness metric.

5. The system of claim 1, wherein collecting user query choices from the next-steps flow elements includes:
replacing the user input at the text field with a graphical element in the text field; and
moving a cursor after the graphical element in the text field.

6. The system of claim 1, wherein the flow choice is at least one of a position, a person, or a posting.

7. The system of claim 2, wherein the user selection includes a selection of a second result presented in the flow choice.

8. A method for assisted creation of a searching query, the method comprising:
presenting a text input field on a graphical user interface (GUI);
presenting a flow-selector in proximity to the text input field in response to receiving user input at the text input field, the flow-selector including a set of flow choices selected based on the user input;
receiving a user selection of a flow choice;
presenting next-steps flow elements in response to the user selection;
collecting user query choices from the next-steps flow elements to populate a query template corresponding to the flow choice; and
executing the query template to produce search results.

9. The method of claim 8, wherein the flow choices include identification of a flow and identification of an example result.

10. The method of claim 8, wherein executing the query template includes:
performing a preliminary search based on an element of the query template to produce intermediate results;
extracting an entity from a result in the intermediate results that is not found in the query template; and
adding the entity to the query template.

11. The method of claim 10, wherein extracting the entity includes:
ranking entities by a closeness metric from an entity in the query template; and
selecting the entity based on the closeness metric.

12. The method of claim 8, wherein collecting user query choices from the next-steps flow elements includes:
replacing the user input at the text field with a graphical element in the text field; and
moving a cursor after the graphical element in the text field.

13. The method of claim 8, wherein the flow choice is at least one of a position, a person, or a posting.

14. The method of claim 9, wherein the user selection includes a selection of a second result presented in the flow choice.

15. A machine readable medium including instructions that, when executed by a machine, cause the machine to perform operations comprising:
presenting a text input field on a graphical user interface (GUI);
presenting a flow-selector in proximity to the text input field in response to receiving user input at the text input field, the flow-selector including a set of flow choices selected based on the user input;
receiving a user selection of a flow choice;
presenting next-steps flow elements in response to the user selection;
collecting user query choices from the next-steps flow elements to populate a query template corresponding to the flow choice; and
executing the query template to produce search results.

16. The machine readable medium of claim 15, wherein the flow choices include identification of a flow and identification of an example result.

17. The machine readable medium of claim 15, wherein executing the query template includes:
performing a preliminary search based on an element of the query template to produce intermediate results;
extracting an entity from a result in the intermediate results that is not found in the query template; and
adding the entity to the query template.

18. The machine readable medium of claim 17, wherein extracting the entity includes:
ranking entities by a closeness metric from an entity in the query template; and
selecting the entity based on the closeness metric.

19. The machine readable medium of claim 15, wherein collecting user query choices from the next-steps flow elements includes:
replacing the user input at the text field with a graphical element in the text field; and
moving a cursor after the graphical element in the text field.

20. The machine readable medium of claim 15, wherein the flow choice is at least one of a position, a person, or a posting.

21. The machine readable medium of claim 16, wherein the user selection includes a selection of a second result presented in the flow choice.
